(19) United States
(12) Patent Application Publication
(10) Pub. No.: US 2011/0311435 A1
(43) Pub. Date: Dec. 22, 2011

(54) METHOD FOR PRODUCING SPINEL-TYPE LITHIUM MANGANATE

(75) Inventors: Yukinobu Yura, Nagoya-city (JP); Nobuyuki Kobayashi, Nagoya-city (JP); Tsutomu Nanataki, Toyoake-city (JP); Kazuyuki Kaigawa, Kitanagoya-city (JP)

(73) Assignee: NGK Insulators, Ltd., Nagoya-City (JP)

(21) Appl. No.: 13/165,233

(22) Filed: Jun. 21, 2011

Related U.S. Application Data
(60) Provisional application No. 61/375,326, filed on Aug. 20, 2010.

(30) Foreign Application Priority Data
Jun. 21, 2010 (JP) PCT/JP2010/060927

(51) Int. Cl. C01G 45/12

(52) U.S. Cl. 423/599

(57) ABSTRACT

The production method of the present invention includes (A) a raw material preparation step of preparing a raw material mixture containing at least a manganese compound; (B) a forming step of forming the raw material mixture prepared through the raw material preparation step into a compact having a longitudinal size L and a maximum size R as measured in a direction perpendicular to the longitudinal direction (i.e., in a thickness direction) such that L/R is 3 or more; (C) a firing step of firing the compact obtained through the forming step; and (D) a crushing step of crushing the fired compact obtained through the firing step.

### BACKGROUND OF THE INVENTION

1. Field of the Invention

The present invention relates to a method for producing spinel-type lithium manganate, which is an oxide containing at least lithium and manganese as constituent elements and having a spinel structure.

2. Description of the Related Art

Such spinel-type lithium manganate is known as a cathode active material for a lithium secondary battery (may be referred to as a “lithium ion secondary battery”) (see, for example, Japanese Patent Application Laid-Open (kokai) Nos. H11-171551, 2000-30707, 2006-252940, and 2007-294119). In contrast to a cathode active material formed of a cobalt oxide or a nickel oxide, a cathode active material formed of spinel-type lithium manganate has the following features: high safety, high rate characteristics, and low cost.

### SUMMARY OF THE INVENTION

However, spinel-type lithium manganate cathode active material poses problems in terms of durability, including deterioration of cycle characteristic at high temperature, and deterioration of storage characteristics at high temperature. An effective approach to solve such a problem is, for example, formation of large-sized cathode active material particles of spinel-type lithium manganate (e.g., formation of particles having a size of 10 μm or more) (see, for example, paragraph [0005] of Japanese Patent Application Laid-Open (kokai) No. 2003-109592).

Upon production of cathode active material particles of spinel-type lithium manganate, generally, grain growth is promoted through firing at high temperature, whereby large-sized particles are obtained. When firing is carried out at excessively high temperature, spinel-type lithium manganate releases oxygen and is decomposed into lithium manganate having a layered rock salt structure, and manganese oxide. During temperature drop, the thus-decomposed substances absorb oxygen and are restored to spinel-type lithium manganate. However, particles which have undergone such a process have many oxygen defects, resulting in deterioration of characteristics (e.g., cell capacity).

Thus, conventional methods have failed to industrially (i.e., stably) produce spinel-type lithium manganate particles which are suitable for use as a cathode active material for a lithium secondary battery, which exhibit excellent characteristics (i.e., contain few impurities and defects), and which exhibit high durability.

As used herein, “spinel-type lithium manganate, which is an oxide containing at least lithium and manganese as constituent elements and having a spinel structure,” which is produced through the method of the present invention, is not limited to that represented by the formula LiMn₂O₄. Specifically, the present invention is suitably applied to a compound represented by the following formula (1) and having a spinel structure.

LiMₓMn₂₋ₓO₄ (1)

In formula (1), M represents at least one element (substitution element) selected from the group consisting of Li, Fe, Ni, Mg, Zn, Al, Co, Cr, Si, Sn, P, V, Sb, Nb, Ta, Mo, and W. The substitution element M may include Ti, Zr, or Ce in addition to the aforementioned at least one element.

In formula (1), x (0 to 0.55) corresponds to the substitution degree of element M. Li is a monovalent cation; Fe, Mn, Ni, Mg, or Zn is a divalent cation; B, Al, Co, or Cr is a trivalent cation; Si, Ti, Sn, Zr, or Ce is a tetravalent cation; P, V, Sb, Nb, or Ta is a pentavalent cation; and Mo or W is a hexavalent cation. Theoretically, any of these elements forms a solid solution with LiMn₂O₄.

When, for example, M is Li, and x is 0.1, the compound of formula (1) is represented by the following chemical formula (2). When M is Li and Al (M1=Li, M2=Al), and x is 0.08 and 0.09 (i.e., x1[Li]=0.08, x2[Al]=0.09), the compound of formula (1) is represented by the following chemical formula (3).

Li_{1.1}Mn_{1.9}O₄ (2)

Li_{1.08}Al_{0.09}Mn_{1.83}O₄ (3)

Co or Sn may be a divalent cation; Fe, Sb, or Ti may be a trivalent cation; Mn may be a trivalent or tetravalent cation; and Cr may be a tetravalent or hexavalent cation. Therefore, the substitution element M may have a mixed valency. The atomic proportion of oxygen is not necessarily 4. So long as the compound of formula (1) can maintain the crystal structure, the atomic proportion of oxygen may be less than or greater than 4.

Substitution of 25 to 55 mol % of Mn by Ni, Co, Fe, Cu, Cr, etc. realizes production of a cathode active material which can be employed for producing a lithium secondary battery exhibiting excellent high-temperature cycle characteristic and rate characteristics. Also, in such a case, energy density can be increased by elevating charge/discharge potential, and thus a lithium secondary battery having an electromotive force as high as 5 V can be produced.

Thus, spinel-type lithium manganate which is produced through the method of the present invention has a spinel structure and is represented by the following formula (4):

Li₁₊ₐM_{y}Mn_{2-a-y}O_{4-σ} (4)

(wherein 0≦y≦0.5, 0≦a≦0.3, 0≦σ≦0.05).

The production method of the present invention comprises:

(A) a raw material preparation step of preparing a raw material mixture containing at least a manganese compound;

(B) a forming step of forming the raw material mixture prepared through the raw material preparation step into a compact having a longitudinal size L and a maximum size R as measured in a direction perpendicular to the longitudinal direction (i.e., in a thickness direction) such that L/R is 3 or more;

(C) a firing step of firing the compact obtained through the forming step; and

(D) a crushing step of crushing the fired compact obtained through the firing step.

Specifically, the aforementioned raw material may contain a lithium compound and a manganese compound. The forming step may be a step of forming a compact wherein L/R is 3 or more and R is 7 to 30 μm.

In the production method of the present invention, a compact elongated in a longitudinal direction (i.e., a rod-like, acicular, or fibrous compact) is obtained through the forming step. When a compact having such a shape is fired, since the amount of the raw material of the compact in a thickness direction is much smaller than that in a longitudinal direction, a limitation is imposed on the grain growth in a thickness direction (i.e., no increase in thickness is observed upon grain growth). In the firing step, preferably, grain growth is allowed to proceed until a single crystal grain is grown in a thickness direction of the compact. In this case, a limitation is also imposed on the grain growth in a longitudinal direction. Thus, the grain size can be controlled to the thickness of the compact.

In such a case, upon growth of a certain crystal grain, other (adjacent) grains are present only along a longitudinal direction. Therefore, when the crystal grain has a cubic shape, only two faces of the crystal grain (i.e., two faces which are generally orthogonal to a longitudinal direction and are aligned along the longitudinal direction) are interactive with the other adjacent grains, and the crystal grain has four free faces (i.e., faces which are not interactive with the other, adjacent grains). Thus, the number of free faces of a crystal grain is larger, as compared with the case where the aforementioned compact has another shape (e.g., bulky, plate-like, polyhedral, or spherical). Therefore, crystal grains having euhedral shapes (intrinsic shapes formed through free growth of crystals) and high crystallinity can be effectively formed. Grain growth proceeds without addition of a grain growth promoting aid to the compact. The fired compact can be effectively milled into primary particles at grain boundaries aligned along a longitudinal direction.

When, for example, cubic crystal grains are arranged in series in a longitudinal direction, each grain is interactive with other adjacent grains at two faces (grain boundaries); i.e., crushing is performed at the two faces. In contrast, when, for example, cubic crystal grains are arranged on the left, right, top and bottom, each grain is interactive with other adjacent grains at six faces (grain boundaries); i.e., crushing is performed at the six faces. In the former case (corresponding to the present invention), energy for crushing can be reduced as compared with the latter case, and thus particles (powder) obtained through crushing exhibit high crystallinity. Therefore, when the thickness (R) of the aforementioned compact is adjusted to, for example, about 7 to about 30 μm, large-sized particles exhibiting excellent characteristics are effectively produced.

As described above, according to the present invention, a fired compact is easily crushed while particle size is controlled, and spinal-type lithium manganate particles exhibiting high crystallinity can be produced. Thus, the production method of the present invention can industrially (i.e., stably) produce spinal-type lithium manganate particles which are suitable for use as a cathode active material for a lithium secondary battery, which exhibit excellent characteristics, and which exhibit high durability.

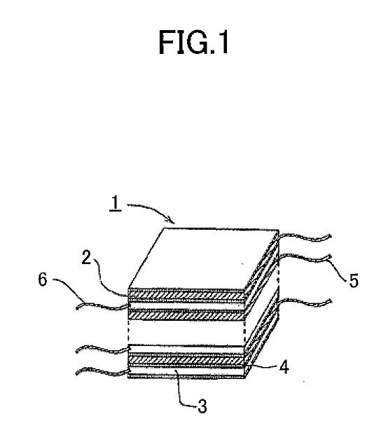

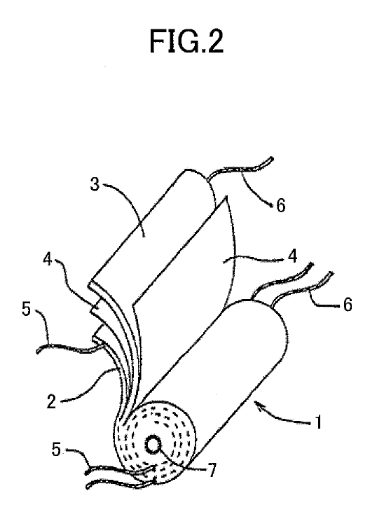

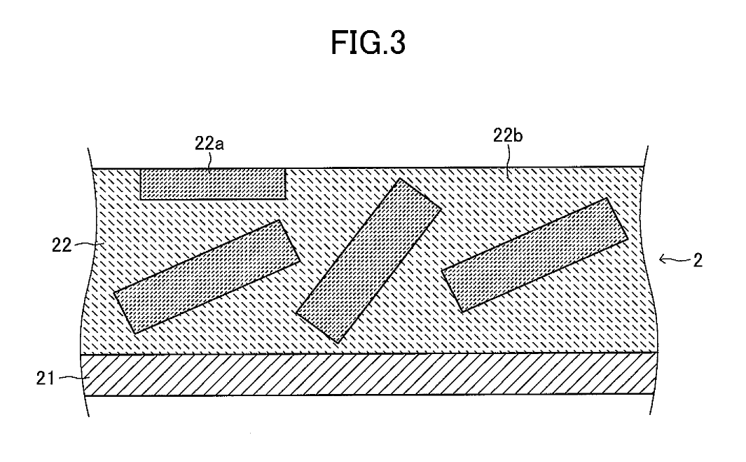

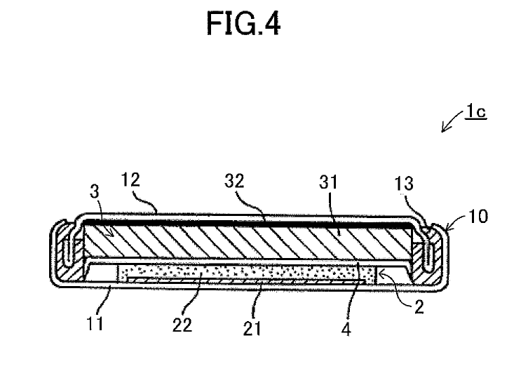

### BRIEF DESCRIPTION OF THE DRAWINGS

[FIG. 1] Sectional view of the schematic configuration of an example lithium secondary battery to which one embodiment of the present invention is applied.

[FIG. 2] Perspective view of the schematic configuration of another example lithium secondary battery to which one embodiment of the present invention is applied.

[FIG. 3] Enlarged sectional view of the cathode plate shown in FIG. 1 or 2.

[FIG. 4] Side sectional view of the schematic configuration of a coin cell for evaluating spinel-type lithium manganate particles (cathode active material particles shown in FIG. 3) produced through one embodiment of the production method of the present invention.

### DETAILED DESCRIPTION OF THE PREFERRED EMBODIMENTS

Preferred embodiments of the present invention will next be described with reference to examples and comparative examples. The following description of the embodiments is nothing more than the specific description of mere example embodiments of the present invention to the possible extent in order to fulfill description requirements (descriptive requirement and enabling requirement) of specifications required by law.

Thus, as will be described later, naturally, the present invention is not limited to the specific configurations of embodiments and examples to be described below. Modifications that can be made to the embodiments and examples are collectively described herein at the end to a maximum possible extent, since insertion thereof into the description of the embodiments would disturb understanding of consistent description of the embodiments.

### 1. Configuration of Lithium Secondary Battery

FIG. 1 is a sectional view of the schematic configuration of an example lithium secondary battery 1 to which one embodiment of the present invention is applied. Referring to FIG. 1, the lithium secondary battery 1 is a so-called liquid-type battery and includes cathode plates 2, anode plates 3, separators 4, cathode tabs 5, and anode tabs 6.

The separator 4 is provided between the cathode plate 2 and the anode plate 3. That is, the cathode plate 2, the separator 4, and the anode plate 3 are stacked in this order. The cathode tabs 5 are electrically connected to the respective cathode plates 2. Similarly, the anode tabs 6 are electrically connected to the respective anode plates 3.

The lithium secondary battery 1 shown in FIG. 1 is configured such that a stack of the cathode plates 2, the separators 4, and the anode plates 3, and an electrolytic solution containing a lithium compound as an electrolyte are liquid-tightly sealed in a specific battery casing (not illustrated).

FIG. 2 is a perspective view of the schematic configuration of another example lithium secondary battery 1 to which one embodiment of the present invention is applied. Referring to FIG. 1, this lithium secondary battery 1 is also a liquid-type battery and includes a cathode plate 2, an anode plate 3, separators 4, cathode tabs 5, anode tabs 6, and a core 7.

The lithium secondary battery 1 shown in FIG. 2 is configured such that an internal electrode body formed through winding, onto the core 7, of a stack of the cathode plate 2, the separators 4, and the anode plate 3, and the aforementioned electrolytic solution are liquid-tightly sealed in a specific battery casing (not illustrated).

FIG. 3 is an enlarged sectional view of the cathode plate 2 shown in FIG. 1 or 2. Referring to FIG. 3, the cathode plate 2 includes a cathode current collector 21 and a cathode layer 22. The cathode layer 22 is configured such that cathode active material particles 22a are dispersed in a binder 22b. The cathode active material particles 22a are crystal particles (primary particles) of spinel-type lithium manganate having a large particle size (specifically, a maximum size of 10 μm or more).

### 2. Method for Producing Cathode Active Material Particles

The cathode active material particles 22a shown in FIG. 3 are produced through a production method including the following four steps: (i) raw material preparation step, (ii) forming step, (iii) firing step, and (iv) crushing and classification step.

(i) Raw material preparation step: A raw material powder mixture containing at least a manganese compound is prepared. The raw material powder mixture may contain a lithium compound. When manganese is substituted by an element other than lithium, the raw material powder mixture contains, for example, an aluminum compound, a magnesium compound, a nickel compound, a cobalt compound, a titanium compound, a zirconium compound, or a cerium compound. The raw material powder mixture may be prepared by using, as a raw material, spinel-type lithium manganate which has been synthesized in advance.

The lithium compound employed may be, for example, Li₂CO₃, LiNO₃, LiOH, Li₂O₂, Li₂O, CH₃COOLi, Li(OCH₃), Li(OC₂H₅), Li(OC₃H₇), Li(OC₄H₉), Li(C₁₁H₁₉O₂), Li₂C₂O₄, or LiCl. The manganese compound employed may be, for example, MnO₂, MnO, Mn₂O₃, Mn₃O₄, MnCO₃, MnOOH, Mn(OCH₃)₂, Mn(OC₂H₅)₂, Mn(OC₃H₇)₂, MnC₂O₄, Mn(CH₃COO)₂, MnCl₂, or Mn(NO₃)₂.

When manganese is substituted by an element other than lithium, the aluminum compound employed may be, for example, α-Al₂O₃, γ-Al₂O₃, AlOOH, Al(OH)₃, Al(OCH₃)₃, Al(OC₂H₅)₃, Al(OC₃H₇)₃, Al(OC₄H₉)₃, AlOCl, or Al(NO₃)₃. The magnesium compound employed may be, for example, MgO, Mg(OH)₂, MgCO₃, Mg(OCH₃)₂, Mg(OC₂H₅)₂, Mg(OC₃H₇)₂, Mg(OC₄H₉)₂, Mg(C₁₁H₁₉O₂)₂, MgCl₂, Mg(C₂H₃O₂)₂, Mg(NO₃)₂, or MgC₂O₄.

The nickel compound employed may be, for example, NiO, Ni(OH)₂, NiNO₃, Ni(C₂H₃O₂)₂, NiC₂O₄, NiCO₃, or NiCl₂. The cobalt compound employed may be, for example, Co₃O₄, CoO, Co(OH)₃, CoCO₃, CoC₂O₄, CoCl₂, Co(NO₃)₂, or Co(OC₃H₇)₂. The titanium compound employed may be, for example, TiO, TiO₂, Ti₂O₃, Ti(OCH₃)₄, Ti(OC₂H₅)₄, Ti(OC₃H₇)₄, Ti(OC₄H₉)₄, or TiCl₄. The zirconium compound employed may be, for example, ZrO₂, Zr(OH)₄, ZrO(NO₃)₂, Zr(OCH₃)₄, Zr(OC₂H₅)₄, Zr(OC₃H₇)₄, Zr(OC₄H₉)₄, or ZrOCl₂. The cerium compound employed may be, for example, CeO₂, Ce(OH)₄, or Ce(NO₃)₃.

The raw material powder mixture may optionally contain a grain growth promoting aid (flux aid or low-melting-point aid). The grain growth promoting aid employed may be, for example, a low-melting-point oxide, chloride, boride, carbonate, nitrate, hydroxide, oxalate, or acetate, an alkoxide, or a permanganate.

Specifically, the grain growth promoting aid employed may be any of the following: NaCl, NaClO₃, Na₂B₄O₇, NaBO₂, Na₂CO₃, NaHCO₃, NaNO₃, NaOH, Na₂C₂O₄, NaOCH₃, NaOC₂H₅, NaOC₃H₇, NaOC₄H₉, KCl, K₂B₄O₇, K₂CO₃, KNO₃, KOH, K₂C₂O₄, KOCH₃, KOC₂H₅, KOC₃H₇, KOC₄H₉, K(C₁₁H₁₉O₂), CaCl₂, CaCO₃, Ca(NO₃)₂, Ca(OH)₂, CaC₂O₄, Ca(CH₃COO)₂·H₂O, Ca(OCH₃)₂, Ca(OC₂H₅)₂, Ca(OC₃H₇)₂, Ca(OC₄H₉)₂, MgCl₂, MgCO₃, Mg(NO₃), Mg(OH)₂, MgC₂O₄, Mg(OCH₃)₂, Mg(OC₂H₅)₂, Mg(OC₃H₇)₂, Mg(OC₄H₉)₂, Mg(C₁₁H₁₉O₂)₂, Bi₂O₃, NaBiO₃, BiCl₃, BiOCl, Bi(NO₃)₃, Bi(OH)₃, Bi(OC₂H₅)₃, Bi(OC₃H₇), Bi(OC₅H₁₁)₃, Bi(C₆H₅)₃, Bi(C₁₁H₁₉O₂)₃, PbO, PbCl₂, PbB₂O₄, PbCO₃, Pb(NO₃)₂, PbC₂O₄, Pb(CH₃COO)₂, Pb(OC₃H₇)₂, Pb(C₁₁H₁₉O₂)₂, Sb₂O₃, SbCl₃, SbOCl, Sb(OCH₃)₃, Sb(OC₂H₅)₃, Sb(OC₃H₇), Sb(OC₄H₉)₃, KMnO₄, NaMnO₄, Ca(MnO₄)₂, Bi₂Mn₄O₁₀, low-melting-point glass (softening point: 500 to 800° C.), etc. Of these, a sodium compound (e.g., NaCl), a potassium compound (e.g., KCl), and a bismuth compound (e.g., Bi₂O₃) are preferred.

The raw material powder mixture may optionally contain, as a nucleus for grain growth, a seed crystal formed of lithium manganate having a spinel structure. The seed crystal has a particle size of 0.1 to 10 μm (preferably 1 to 6 μm). The amount of the seed crystal added is 1 to 25 vol. % (preferably 2 to 20 vol. %) on the basis of the total amount of a lithium manganate compact obtained through firing. No particular limitation is imposed on the method for producing the seed crystal. The seed crystal employed is preferably, for example, fine powder obtained by sieving of particles of intended size (cathode active material particles 22a) through the below-described classification step.

The production method of the present invention can produce spinel-type lithium manganate (cathode active material) particles of intended size (particle size) exhibiting excellent characteristics and high durability without addition of a grain growth promoting aid or a seed crystal. However, either or both of these may be appropriately added for further improving crystallinity or yield. When a seed crystal and a grain growth promoting aid are added in combination, the grain growth promoting aid may be added separately from the seed crystal, or may be added in the form of being bonded to the seed crystal.

If necessary, the powder mixture may be crushed. The powder mixture preferably has a particle size of 10 μm or less. When the powder mixture has a particle size of more than 10 μm, the powder mixture may be dry- or wet-milled so as to attain a particle size of 10 μm or less. No particular limitation is imposed on the crushing method, and crushing may be carried out through a method using, for example, a pot mill, a bead mill, a hammer mill, or a jet mill.

(ii) Forming step: A compact elongated in a longitudinal direction (i.e., a rod-like, acicular, or fibrous compact) is formed from the raw material powder mixture prepared through the aforementioned raw material preparation step. This compact is formed to have a longitudinal size L and a maximum size R (thickness) as measured in a direction perpendicular to the longitudinal direction (i.e., in a thickness direction) such that the aspect ratio (L/R) is 3 or more.

No particular limitation is imposed on the forming method, and, for example, extrusion molding, gel cast molding, or a similar technique may be employed. When extrusion molding is carried out, a wire-shaped compact extruded through a nozzle may be wound on, for example, a winding reel before drying. Also, the aforementioned elongated compact is obtained by cutting a primary compact (sheet-like or thinly sliced compact) into elongated pieces, the primary compact being formed through, for example, the doctor blade method or the drum dryer method. Alternatively, the aforementioned elongated compact is obtained by forming a sol precursor into a rod-like or fibrous shape, followed by gelation. In this case, a primary compact formed of the precursor may be wound on, for example, a winding reel before gelation.

(iii) Firing (thermal treatment) step: A compact obtained through the aforementioned forming step is fired (thermally treated) at 830 to 1,050° C. Through this step, the compact is formed into a fired compact of spinel-type lithium manganate (cathode active material). When the aforementioned compact is placed in a crucible or a sagger upon firing, the compact may be subjected to a process (e.g., folding or cutting) in advance so that the compact has an appropriate length or shape and the aspect ratio (L/R) becomes 3 or more.

When the firing temperature is lower than 830° C., grain growth may fail to proceed sufficiently, whereas when the firing temperature exceeds 1,050° C. (e.g., reaches about 1,100° C.), spinel-type lithium manganate may release oxygen and may be decomposed into lithium manganate having a layered rock salt structure, and manganese oxide.

Firing may be carried out in an oxygen atmosphere (high oxygen partial pressure) (in this case, the oxygen partial pressure is preferably, for example, 50% or more of the pressure of the firing atmosphere). In this case, spinel-type lithium manganate is less likely to release oxygen, and thus the above-described oxygen defects or decomposition is effectively suppressed. In the case where the aforementioned grain growth promoting aid or seed crystal is contained in the raw material, even when the firing temperature is relatively low (e.g., about 900° C.), grain growth is promoted, and thus improvement of crystallinity or similar effects are expected to be attained.

When heating rate is controlled during firing, primary particles having uniform size can be formed through firing. The heating rate may be, for example, 50 to 500 degrees (° C.)/hour. When the above-formed compact is maintained at a low temperature and then fired at a firing temperature, primary particles can be uniformly grown. When, for example, the compact is fired at 900° C., the low temperature may be 400 to 800° C. Primary particles can also be uniformly grown by maintaining the above-formed compact at a temperature higher than the firing temperature to thereby form crystal nuclei, followed by firing at the firing temperature. In this case, when, for example, the compact is fired at 900° C., the temperature higher than the firing temperature may be 1,000° C. or thereabouts.

(iv) Crushing and classification step: A fired compact of spinel-type lithium manganate (cathode active material) obtained through the aforementioned firing step is subjected to wet or dry crushing and classification, to thereby produce powder of spinel-type lithium manganate (cathode active material) particles having an intended size.

No particular limitation is imposed on the crushing method, and crushing may be carried out by, for example, pressing the fired compact onto a mesh or screen having an opening size of 5 to 100 μm. Alternatively, crushing may be carried out by means of, for example, a pot mill, a bead mill, a hammer mill, or a jet mill. No particular limitation is imposed on the classification method, and classification may be carried out through, for example, elutriation or sieving by use of a mesh having an opening size of 5 to 100 μm. Alternatively, classification may be carried out by means of, for example, an airflow classifier, a sieve classifier, or an elbow jet classifier.

The thus-obtained particles of intended size may be subjected to thermal retreatment at a temperature lower than the aforementioned firing temperature (e.g., at 600 to 750° C. for 3 to 48 hours in air or an oxygen atmosphere). This thermal retreatment restores oxygen defects and crystallinity disturbed during crushing. The aforementioned thermal retreatment may be carried out before crushing (i.e., upon temperature drop in the first firing) by maintaining the fired compact at an intended temperature for a certain period of time, or by reducing a temperature lowering rate (e.g., 5 to 100 degrees (° C.)/h) from the firing temperature to an intended temperature (e.g., 600 to 750° C.). This thermal retreatment exerts the effect of restoring oxygen defects. When thermal retreatment is carried out after crushing (or after classification), the thus-retreated powder may be subjected to crushing or classification again. In this case, crushing or classification may be performed through, for example, the aforementioned method.

Next will be described in detail specific examples of the above-described production method, and the results of evaluation of particles produced through the production methods of the specific examples.

2-1. Extrusion Molding—Absence of Substitution Element Other than Lithium

### 2-1-1. Production Method

(i) Raw Material Preparation Step

Li₂CO₃ powder (product of The Honjo Chemical Corporation, fine grade, average particle size: 3 μm) and MnO₂ powder (product of Tosoh Corporation, electrolytic manganese dioxide, FM grade, average particle size: 5 μm, purity: 95%) were weighed so as to attain a composition of Li_{1.1}Mn_{1.9}O₄.

The thus-weighed materials (100 parts by weight) and water serving as a dispersion medium (120 parts by weight) were placed in a cylindrical wide-mouthed bottle made of a synthetic resin and subjected to wet-mixing and crushing by means of a ball mill (zirconia balls having a diameter of 5 mm). The resultant slurry was dried to thereby prepare a raw material powder mixture having a median size of 0.5 to 3 μm. The median size was controlled by regulating the wet-mixing time by means of the ball mill.

The raw material powder mixture (100 parts by weight) was uniformly mixed with methylcellulose serving as an organic binder (5 to 10 parts by weight), a surfactant (0.1 to 1 part by weight), and water, and the mixture was kneaded, to thereby prepare kneaded clay for forming. The amount (part(s) by weight) of water was adjusted so that the hardness of the kneaded clay became 8 to 25 mm. The hardness of the kneaded clay was determined by means of a clay hardness tester (trade name: Clay Hardness Tester, product of NGK Insulators, Ltd.).

### (ii) Forming Step (Extrusion Step)

The kneaded clay was formed into rod-like compacts by means of an extrusion molding machine. The thus-formed compacts were dried by means of a dryer. The thickness of the rod-like compacts (see the below-given Table 1) was controlled by appropriately regulating extrusion conditions (e.g., opening size of a nozzle).

(iii) Firing (Thermal Treatment) Step

The thus-dried rod-like compacts were folded so as to attain a specific length (see the below-given Table 1), and placed in a sagger made of alumina (dimensions: 90 mm×90 mm×60 mm in height), followed by degreasing under an uncovered condition at 600° C. for two hours. Thereafter, firing was carried out under specific conditions (temperature, time, and firing atmosphere (see the below-given Table 1)).

As shown in Table 1, in Examples 1 to 8, the formed compacts were found to have a thickness of 7 to 30 μm and an aspect ratio of 3 or more, and the fired compacts were found to have a thickness of 5 to 20 μm. In each of the fired compacts of the Examples, grain growth proceeded until a single crystal grain was completed in a thickness direction of the compact, and grain growth in a longitudinal direction was limited by the thickness of the compact; i.e., a plurality of large crystal grains (grain size: 5 to 20 μm) were arranged in series in a longitudinal direction.

In Comparative Example 1, the formed compacts were found to have a thickness of 5 μm and an aspect ratio of less than 3. In each of the fired compact of Comparative Example 1, about two small crystal grains (grain size: about 3 μm) were arranged in series in a longitudinal direction. In Comparative Example 2, the formed compacts were found to have a thickness of 5 μm and an aspect ratio of 3 or more. In each of the fired compacts of Comparative Example 2, many small crystal grains (grain size: about 3 μm) were arranged in series in a longitudinal direction. In Comparative Examples 3 and 4, the formed compacts were found to have a thickness as large as 32 μm. In each of the fired compacts of these Comparative Examples, more than one grains are grown in the thickness direction, and a plurality of crystal grains were arranged in series in a thickness direction. Conceivably, this is attributed to the fact that each compact has a large thickness, and thus a plurality of nuclei from which grain growth starts are formed in a thickness direction.

(iv) Crushing and Classification Step

The rod-like fired compacts obtained through the firing (thermal treatment) step were placed on a polyester mesh having an opening size of 5 to 100 μm, and then the compacts were gently pressed against the mesh with a spatula, to thereby mill the compacts.

In each of the fired compacts of Comparative Examples 1 and 2 and Examples 1 to 8, the particle size corresponded to the thickness of the fired compact, and a plurality of crystal grains were arranged in series in a longitudinal direction; i.e., adjacent grains were present only along a longitudinal direction. Thus, since a crystal grain of each fired compact was interactive with other adjacent grains at only two faces (grain boundaries), the fired compact was easily crushed through the aforementioned method. Since the fired compact required only a small amount of energy for crushing, the resultant particles (powder) exhibited high crystallinity.

In each of the fired compacts of Comparative Examples 3 and 4, a plurality of crystal grains were arranged in series in a thickness direction; i.e., adjacent grains were present not only along a longitudinal direction but also along a thickness direction. Thus, since a crystal grain of each fired compact was interactive with other adjacent grains at three or more faces (grain boundaries), the fired compact was insufficiently crushed through the aforementioned method.

Powder obtained through crushing was dispersed in ethanol, and then subjected to ultrasonic treatment (38 kHz, 5 minutes) by means of an ultrasonic cleaner. Thereafter, in the cases of Comparative Examples 1 and 2, powder particles which had been passed through a polyester mesh having an average opening size of 5 μm were recovered, to thereby remove insufficiently crushed fired compacts. In the cases of Examples 1 to 8 and Comparative Examples 3 and 4, powder particles were caused to pass through a polyester mesh having an average opening size of 5 μm, and particles remaining on the mesh were recovered, to thereby remove particles (size: 5 μm or less) which had been formed during firing or crushing.

(v) Thermal Retreatment Step

Powder particles obtained through the aforementioned crushing and classification step and having an intended particle size were thermally treated in air at 650° C. for 24 hours, to thereby produce particles of spinel-type lithium manganate (composition: Li_{1.1}Mn_{1.9}O₄) employed as cathode active material particles 22a.

### 2-1-2. Evaluation Method

FIG. 4 is a side sectional view of the schematic configuration of a coin cell 1c for evaluating spinel-type lithium manganate particles (cathode active material particles 22a shown in FIG. 3) produced through one embodiment of the production method of the present invention.

The configuration of the coin cell 1c for evaluation use shown in FIG. 4 will next be described. The coin cell 1c was fabricated as follows. A cathode current collector 21, a cathode layer 22, a separator 4, an anode layer 31, and an anode current collector 32 were stacked in this order. The resultant stack and an electrolyte were liquid-tightly sealed in a cell casing 10 (including a cathode container 11, an anode container 12, and an insulation gasket 13).

Specifically, spinel-type lithium manganate particles obtained through the aforementioned production method (cathode active material) (5 mg), acetylene black serving as an electrically conductive agent, and polytetrafluoroethylene (PTFE) serving as a binder were mixed in proportions by mass of 5:5:1, to thereby prepare a cathode material. The thus-prepared cathode material was placed on an aluminum mesh (diameter: 15 mm) and press-formed at 10 kN by means of a pressing machine, to thereby form the cathode layer 22.

The coin cell 1c was fabricated by use of the above-formed cathode layer 22; an electrolytic solution; the anode layer 31 formed of a lithium metal plate; the anode current collector 32 formed of a stainless steel plate; and the separator 4 formed of a lithium ion permeable polyethylene film. The electrolytic solution was prepared as follows: ethylene carbonate (EC) was mixed with an equivolume of diethyl carbonate (DEC) to thereby prepare an organic solvent, and LiPF₆ was dissolved in the organic solvent at a concentration of 1 mol/L.

(A) Initial Capacity (mAh/g)

One cycle consists of the following charge and discharge operations at a test temperature of 20° C.: constant-current charge is carried out at 0.1 C rate of current until the cell voltage becomes 4.3 V; subsequently, constant-voltage charge is carried out under a current condition of maintaining the cell voltage at 4.3 V until the current drops to 1/20, followed by 10 minutes rest; and then constant-current discharge is carried out at 1 C rate of current until the cell voltage becomes 3.0 V, followed by 10 minutes rest. A total of three cycles were performed under a condition of 20° C. The discharge capacity in the third cycle was measured, and the thus-measured capacity was employed as initial capacity.

### (B) Rate Characteristic (%)

One cycle consists of the following charge and discharge operations at a test temperature of 20° C.: constant-current charge is carried out at 0.1 C rate of current until the cell voltage becomes 4.3 V; subsequently, constant-voltage charge is carried out under a current condition of maintaining the cell voltage at 4.3 V until the current drops to 1/20, followed by 10 minutes rest; and then constant-current discharge is carried out at 0.1 C rate of current until the cell voltage becomes 3.0 V, followed by 10 minutes rest. A total of three cycles were performed under a condition of 20° C. The discharge capacity in the third cycle was measured, and the thus-measured capacity was employed as discharge capacity C_{(0.1 C)}.

One cycle consists of the following charge and discharge operations at a test temperature of 20° C.: constant-current charge is carried out at 0.1 C rate of current until the cell voltage becomes 4.3 V; subsequently, constant-voltage charge is carried out under a current condition of maintaining the cell voltage at 4.3 V until the current drops to 1/20, followed by 10 minutes rest; and then constant-current discharge is carried out at 10 C rate of current until the cell voltage becomes 3.0 V, followed by 10 minutes rest. A total of three cycles were performed under a condition of 20° C. The discharge capacity in the third cycle was measured, and the thus-measured capacity was employed as discharge capacity C_{(10 C)}. Rate characteristic (%) (capacity maintenance percentage) was defined as a value calculated by dividing the discharge capacity C_{(10C)} by the discharge capacity C_{(0.1 C)}.

### (C) Cycle Characteristic (%)

The above-produced cell was subjected to cyclic charge-discharge at a test temperature of 45° C. The cyclic charge-discharge repeats: charge at 1 C rate of constant current and constant voltage until 4.3 V is reached, and discharge at 1 C rate of constant current until 3.0 V is reached. Cycle characteristic (%) (durability) was defined as a value calculated by dividing the discharge capacity of the cell as measured after 100 repetitions of cyclic charge-discharge by the initial capacity of the cell.

### 2-1-3. Evaluation Results

Table 1 shows the results of experiments in which the forming step and the firing step were performed under different conditions.

TABLE 1

| | Forming step | | | | | | | | |
|---|---|---|---|---|---|---|---|---|---|
| | Thickness | Length of | | | | | | | |
| | of rod-like | rod-like | | Firing step | | | Cell characteristics | | |
| | formed | formed | | Firing | Holding | | Initial | Rate | Cycle |
| | compact: R | compact: L | Aspect | temperature | time | Firing | capacity | characteristic | characteristic |
| | (μm) | (μm) | ratio | (° C.) | (h) | atmosphere | (mAh/g) | (%) | (%) |
| Comp. Ex. 1 | 5 | 10 | 2 | 900 | 16 | Air | 103 | 95 | 76 |
| Comp. Ex. 2 | 5 | 100 | 20 | 900 | 16 | Air | 103 | 96 | 78 |
| Ex. 1 | 7 | 21 | 3.0 | 830 | 16 | Air | 103 | 88 | 90 |
| Ex. 2 | 7 | 21 | 3.0 | 900 | 16 | Air | 103 | 90 | 92 |
| Ex. 3 | 10 | 100 | 10 | 900 | 10 | Air | 104 | 91 | 94 |
| Ex. 4 | 15 | 500 | 33 | 900 | 10 | Air | 104 | 92 | 96 |
| Ex. 5 | 20 | 1,000 | 50 | 900 | 10 | Air | 104 | 92 | 98 |
| Ex. 6 | 30 | 10,000 | 333 | 900 | 10 | Air | 104 | 91 | 97 |
| Ex. 7 | 20 | 10,000 | 500 | 950 | 10 | Air | 103 | 88 | 92 |
| Ex. 8 | 20 | 10,000 | 500 | 1,000 | 10 | Oxygen | 104 | 92 | 98 |
| Comp. Ex. 3 | 32 | 10,000 | 313 | 900 | 16 | Air | 104 | 80 | 90 |
| Comp. Ex. 4 | 32 | 90 | 2.8 | 900 | 16 | Air | 104 | 78 | 90 |

As shown in Table 1, in the cases of Examples 1 to 8 wherein rod-like formed compacts had a thickness of 7 to 30 μm and an aspect ratio of 3 or more, good initial capacity, rate characteristic, and cycle characteristic were attained. This is attributed to the fact that since fired compacts were easily crushed, a large number of single-grain particles having no grain boundaries were formed, and deterioration of crystallinity, which would otherwise be caused by crushing, was suppressed, and that crystal grains had a size as large as 5 to 20 μm.

In contrast, in the case of Comparative Example 1 wherein rod-like formed compacts had very small thickness and low aspect ratio, or in the case of Comparative Example 2 wherein rod-like formed compacts had very small thickness, cycle characteristic was lowered. This is attributed to a small grain size of about 3 μm. In the case of Comparative Example 3 or 4 wherein rod-like formed compacts had very large thickness, rate characteristic was lowered. This is attributed to the fact that insufficient crushing resulted in formation of a large number of connected particles having grain boundaries. In this case, sufficient crushing was attained by using, for example, a jet mill; i.e., means which provides higher energy for crushing than in the case of crushing by a mesh. However, this crushing resulted in deterioration of crystallinity. Although rate characteristic was improved through this crushing, cycle characteristic was considerably deteriorated.

2-2. Extrusion Molding—Presence of Substitution Element Other than Lithium

### 2-2-1. Production Method

Li₂CO₃ powder (product of The Honjo Chemical Corporation, fine grade, average particle size: 3 μm), MnO₂ powder (product of Tosoh Corporation, electrolytic manganese dioxide, FM grade, average particle size: 5 μm, purity: 95%), and Al(OH)₃ powder (trade name “Higilite (registered trademark) H-43M,” product of Showa Denko K.K., average particle size: 0.8 μm) were weighed so as to attain a composition of Li_{1.08}Al_{0.09}Mn_{1.83}O₄.

The thus-weighed materials (100 parts by weight) and water serving as a dispersion medium (120 parts by weight) were placed in a cylindrical wide-mouthed bottle made of a synthetic resin and subjected to wet-mixing and crushing by means of a ball mill (zirconia balls having a diameter of 5 mm). The resultant slurry was dried to thereby prepare a raw material powder mixture having a median size of 0.5 to 3 μm. The median size was controlled by regulating the wet-mixing time by means of the ball mill.

The raw material powder mixture obtained through wet-mixing and crushing was prepared into kneaded clay in a manner similar to that described above. The thus-prepared kneaded clay was subjected to the forming step (extrusion step), the firing (thermal treatment) step, the crushing and classification step, and the thermal retreatment step, to thereby produce particles of spinel-type lithium manganate (composition: Li_{1.08}Al_{0.09}Mn_{1.83}O₄) employed as cathode active material particles 22a.

### 2-2-2. Evaluation Results

Table 2 shows the results of experiments in which the forming step (extrusion step) and the firing step were performed under different conditions in a manner similar to that described above. As shown in Table 2, even when a portion of Mn was substituted by lithium and aluminum, results similar to those shown in Table 1 were obtained.

TABLE 2

| | Forming step | | | | | | | | |
|---|---|---|---|---|---|---|---|---|---|
| | Thickness | Length of | | | | | | | |
| | of rod-like | rod-like | | Firing step | | | Cell characteristics | | |
| | formed | formed | | Firing | Holding | | Initial | Rate | Cycle |
| | compact: R | compact: L | Aspect | temperature | time | Firing | capacity | characteristic | characterstic |
| | (μm) | (μm) | ratio | (° C.) | (h) | atmosphere | (mAh/g) | (%) | (%) |
| Comp. Ex. 5 | 5 | 10 | 2 | 900 | 16 | Air | 103 | 94 | 78 |
| Comp. Ex. 6 | 5 | 100 | 20 | 900 | 16 | Air | 103 | 95 | 80 |
| Ex. 9 | 7 | 21 | 3.0 | 830 | 16 | Air | 103 | 87 | 92 |
| Ex. 10 | 7 | 21 | 3.0 | 900 | 16 | Air | 104 | 88 | 93 |
| Ex. 11 | 10 | 100 | 10 | 900 | 10 | Air | 103 | 90 | 95 |
| Ex. 12 | 15 | 500 | 33 | 900 | 10 | Air | 104 | 91 | 99 |
| Ex. 13 | 20 | 1,000 | 50 | 900 | 10 | Air | 103 | 92 | 99 |
| Ex. 14 | 30 | 10,000 | 333 | 900 | 10 | Air | 104 | 90 | 99 |
| Ex. 15 | 20 | 10,000 | 500 | 950 | 10 | Air | 104 | 87 | 93 |
| Ex. 16 | 20 | 10,000 | 500 | 1,000 | 10 | Oxygen | 104 | 92 | 99 |
| Comp. Ex. 7 | 32 | 10,000 | 313 | 900 | 16 | Air | 103 | 79 | 91 |
| Comp. Ex. 8 | 32 | 90 | 2.8 | 900 | 16 | Air | 104 | 76 | 91 |

### 2-3. Tape Forming (Comparative Example)

### 2-3-1. Production Method

(i) Raw Material Preparation Step

Li₂CO₃ powder (product of The Honjo Chemical Corporation, fine grade, average particle size: 3 μm), MnO₂ powder (product of Tosoh Corporation, electrolytic manganese dioxide, FM grade, average particle size: 5 μm, purity: 95%), and Al(OH)₃ powder (trade name “Higilite (registered trademark) H-43M,” product of Showa Denko K.K., average particle size: 0.8 μm) were weighed so as to attain a composition of Li_{1.1}Mn_{1.9}O₄ or Li_{1.08}Al_{0.09}Mn_{1.83}O₄.

The thus-weighed materials (100 parts by weight) and an organic solvent (mixture of toluene and an equiamount of isopropanol) serving as a dispersion medium (100 parts by weight) were placed in a cylindrical wide-mouthed bottle made of a synthetic resin and subjected to wet-mixing and crushing by means of a ball mill (zirconia balls having a diameter of 5 mm).

(ii) Forming Step (Tape Forming Step)

The raw material powder mixture obtained through wet-mixing and crushing was mixed with polyvinyl butyral (trade name “S-lec BM-2,” product of Sekisui Chemical Co. Ltd.) serving as a binder (10 parts by weight), a plasticizer (trade name “DOP,” product of Kurogane Kasei Co., Ltd.) (4 parts by mass), and a dispersant (trade name “Rheodol SP-030,” product of Kao Corporation) (2 parts by mass), to thereby prepare a slurry material for forming. The thus-prepared slurry material was stirred under reduced pressure for defoaming, so that the viscosity of the slurry was adjusted to 4,000 mPa·s. The viscosity-adjusted slurry material was formed into a sheet-like compact on a PET film through the doctor blade method. The thickness of the sheet-like compact was 20 μm as measured after drying.

(iii) Firing (Thermal Retreatment) Step

A 300 mm square piece was cut out from the sheet-like compact separated from the PET film by means of a cutter, and the piece was crumpled and placed in a sagger made of alumina (dimensions: 90 mm×90 mm×60 mm in height), followed by, under an uncovered condition (i.e., in air), degreasing at 600° C. for two hours and subsequent firing at 900° C. for 10 hours.

(iv) Crushing and Classification Step

Similar to the case of the aforementioned rod-like fired compacts, the sheet-like fired compact obtained through the firing (thermal treatment) step was placed on a polyester mesh, and then the compact was gently pressed against the mesh with a spatula for crushing of the compact. However, the fired compact failed to be crushed sufficiently, since the fired compact contained many fine grains and exhibited high grain boundary strength.

Powder obtained through crushing was dispersed in ethanol, and then subjected to ultrasonic treatment (38 kHz, 5 minutes) by means of an ultrasonic cleaner. Thereafter, powder particles were caused to pass through a polyester mesh having an average opening size of 5 μm, and particles remaining on the mesh were recovered, to thereby remove particles (size: 5 μm or less) which had been formed during firing or crushing.

(v) Thermal Retreatment Step

Thermal retreatment was carried out in a manner similar to that described above, to thereby produce particles of spinel-type lithium manganate (composition: Li_{1.1}Mn_{1.9}O₄ or Li_{1.08}Al_{0.09}Mn_{1.83}O₄) employed as cathode active material particles 22a.

### 2-3-2. Evaluation Results

A coin cell 1c was produced in a manner similar to that described above for evaluation of the aforementioned characteristics. However, the characteristics of the cell failed to be evaluated, since the lithium manganate particles contained many coarse polycrystalline grains due to insufficient crushing of the lithium manganate fired compact. In this case, sufficient crushing was attained by using, for example, a jet mill; i.e., means which provides higher energy for crushing than in the case of crushing by a mesh. However, this crushing resulted in deterioration of crystallinity. Although rate characteristic was improved through this crushing, cycle characteristic was considerably deteriorated.

Results obtained in the case where gel cast molding was employed were similar to those as obtained in the case of extrusion molding.

### 3. Modifications

The above-described embodiment and specific examples are, as mentioned above, mere examples of the best mode of the present invention which the applicant of the present invention contemplated at the time of filing the present application. The above-described embodiment and specific examples should not be construed as limiting the invention. Various modifications to the above-described embodiment and specific examples are possible, so long as the invention is not modified in essence.

Several modifications will next be exemplified. Needless to say, even modifications are not limited to those described below. Limitingly construing the present invention based on the above-described embodiment and the following modifications impairs the interests of an applicant (particularly, an applicant who is motivated to file as quickly as possible under the first-to-file system) while unfairly benefiting imitators, and is thus impermissible.

Needless to say, the constitution of the above-described embodiment and the constitutions of the modifications to be described below are entirely or partially applicable in appropriate combination, so long as no technical inconsistencies are involved.

(1) The present invention is not limited to the constitution which is specifically disclosed in the description of the above embodiments. That is, the application of the present invention is not limited to the specific cell configurations shown in FIGS. 1, 2, and 4. Also, no particular limitation is imposed on the number of the cathode plates 2, the separators 4, and the anode plates 3 to be stacked together.

(2) The present invention is not limited to the production methods disclosed specifically in the above-described embodiments. For example, the firing step may be performed by means of a rotary kiln. In this case, when a grain growth promoting aid (e.g., a bismuth compound) is added, a component of the aid (e.g., bismuth) is removed more efficiently.

When a bismuth compound is employed as a grain growth promoting aid, the bismuth compound may be suitably a compound of bismuth and manganese (e.g., Bi₂Mn₄O₁₀) (even when Bi₂O₃ is employed, Bi₂Mn₄O₁₀ may be generated in the course of firing). In this case, during firing, bismuth evaporates, and manganese becomes lithium manganate, thereby absorbing lithium excessively present in the form of solid solution. This produces spinel-type lithium manganate (cathode active material) having smaller amounts of impurities.

The aforementioned thermal retreatment may also serve as a lithium incorporation step. That is, a lithium compound may be added not before the forming step, but in the thermal retreatment step. In this case, the thermal treatment temperature in the lithium incorporation step is preferably 500° C. to 800° C.

Specifically, lithium manganate may be produced through, for example, the following procedure: a powder mixture of manganese oxide and alumina is formed into an elongated compact (rod-like, acicular, or fibrous compact) and fired, and then a lithium compound is added to the fired compact, followed by further firing. Alternatively, lithium manganate may be produced by forming lithium manganate crystals having high lithium content, and then adding manganese oxide or alumina to the crystals, followed by further firing.

(3) Needless to say, those modifications which are not particularly referred to are also encompassed in the technical scope of the present invention, so long as the invention is not modified in essence.

Those components which partially constitute means for solving the problems to be solved by the present invention and are operationally or functionally expressed encompass not only the specific structures disclosed above in the description of the aforementioned embodiments and modifications but also any other structures that can implement the operations or functions of the components. Further, the contents (including specifications and drawings) of the prior application and publications cited herein can be incorporated herein as appropriate by reference.

1. A method for producing spinel-type lithium manganate, which is an oxide containing at least lithium and manganese as constituent elements and having a spinel structure, characterized in that the method comprises:
a raw material preparation step of preparing a raw material mixture containing at least a manganese compound;
a forming step of forming the raw material mixture prepared through the raw material preparation step into a compact having a longitudinal size L and a maximum size R as measured in a direction perpendicular to the longitudinal direction such that L/R is 3 or more;
a firing step of firing the compact obtained through the forming step; and
a crushing step of crushing the fired compact obtained through the firing step.

2. A method for producing spinel-type lithium manganate according to claim 1, wherein the forming step is a step of forming a compact in which L/R is 3 or more and R is 7 to 30 μm.

3. A method for producing spinel-type lithium manganate according to claim 1, wherein the raw material preparation step is a step of preparing a raw material mixture containing at least a lithium compound and a manganese compound.

4. A method for producing spinel-type lithium manganate according to claim 1, wherein the raw material preparation step is a step of preparing a raw material mixture containing at least lithium manganate.
